(19) United States
(12) Patent Application Publication
(10) Pub. No.: US 2011/0265333 A1
(43) Pub. Date: Nov. 3, 2011

(54) DUAL PURPOSE UTILITY KNIFE

(76) Inventor: Glenn Covey, Plainfield, IL (US)

(21) Appl. No.: 12/772,671

(22) Filed: May 3, 2010

(51) Int. Cl. B26B 9/00; B26B 29/02

(52) U.S. Cl. 30/353; 30/164

(57) ABSTRACT

A utility knife suitable for use both as a knife and a sheet cutter includes a casing for securing a blade having cutting edges on opposing sides. The casing includes a gathering finger extending from one side of the casing and spaced from a side of the casing to define a guideway leading to an exposed first edge of the blade for cutting sheet material. The finger is disposed in a spaced manner over the first edge of the blade to prevent inadvertent contact with the blade. A second opposite edge of the blade extends out of the opposite side of the casing to expose a forward portion of the blade for more conventional use as a knife. The blade is manually movable to a retracted portion wherein the blade's second edge is disposed within the casing.

### FIELD OF THE INVENTION

This invention relates generally to knives, and is particularly directed to a utility knife capable of use as a conventional knife as well as a sheet cutter.

### BACKGROUND OF THE INVENTION

Knives take on various forms depending upon there intended use. For example, carpet cutting knives generally include a single blade having a pair of sharpened corners fixedly positioned within an outer casing adapted for manual grasping by a user. The blade is generally trapezoidal in shape and allows for interchanging the two blade corner portions after one corner of the blade has been extensively used and exhibits reduced sharpness and limited cutting capability.

Another type of utility knife is adapted for cutting sheet-like material such as shrink wrap, which also employs a single fixed blade and is limited to the cutting of thin materials and is not adapted for use of as a conventional knife. Thus, the two aforementioned applications require the use of a different type of knife, with each type of knife limited to its intended purpose.

The present invention is directed to a utility knife employing a single double-edged blade disposed in a generally closed casing which is adapted for use as a conventional knife as well as a sheet cutter.

### OBJECTS AND SUMMARY OF THE INVENTION

Accordingly, it is an object of the present invention to provide a utility knife equally suitable for use as a conventional knife and as a sheet cutter using a single blade.

It is another object of the present invention to provide a utility knife having a generally rectangular double-edged blade movable between an extended, use position and a retracted, stored position, which use any of the blade's four corners in conventional knife cutting and an inner portion of either of its sharpened edges in cutting sheet-like materials. Yet another object of the present invention is to provide a dual purpose utility knife which is easy and safe to use, employs a single blade for both functions, and uses the sharpened edges of the blade in a manner which prolongs the useable life of the blade.

The present invention contemplates a utility knife comprising a casing containing a generally rectangular, double-edged cutting blade; a first edge portion of the casing defining a first opening exposing a first edge of the cutting blade for cutting an object; a second end portion of the casing extending from the first portion and forming a handle for grasping by a user of the knife; and a finger extending from the first portion of the casing and forming an elongated slot with the first portion, wherein the slot includes a second opening exposing a second opposed edge of the cutting blade, and wherein the slot is adapted to receive and direct a sheet-like material into engagement with the second edge of the cutting blade for cutting the sheet-like material.

### BRIEF DESCRIPTION OF THE DRAWING

The appended claims set forth those novel features which character the invention. However, the invention itself, as well as further objects and advantages thereof, will best be understood by reference to the following detailed description of a preferred embodiment taken in conjunction with the accompanying drawings, where like reference characters identify like elements throughout the various figures in which:

FIG. 1 is a side view of the inventive knife with both sides of the casing assembled, and a blade inserted in the use position; and

FIG. 2 is a view similar to FIG. 1 with the side of the casing closest to the viewer removed to see the mounting of the blade in the use position and a storage area for replacement blades.

### DETAILED DESCRIPTION OF THE ILLUSTRATED EMBODIMENT

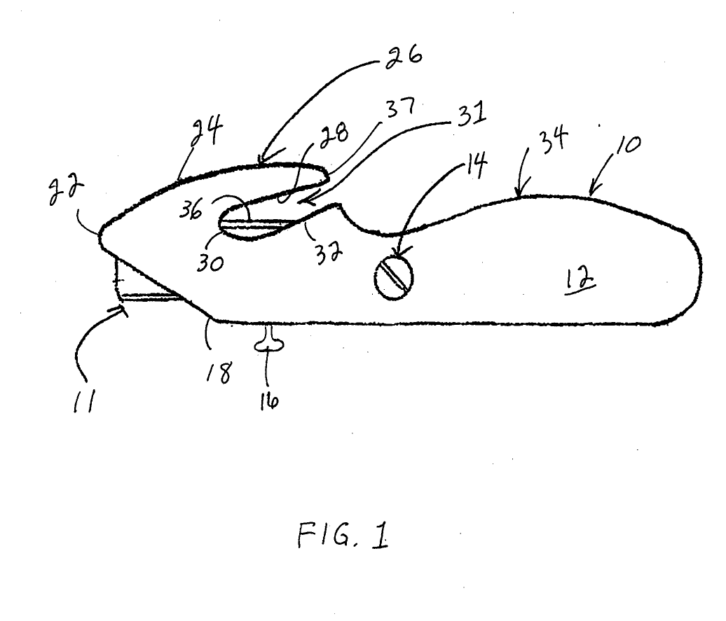

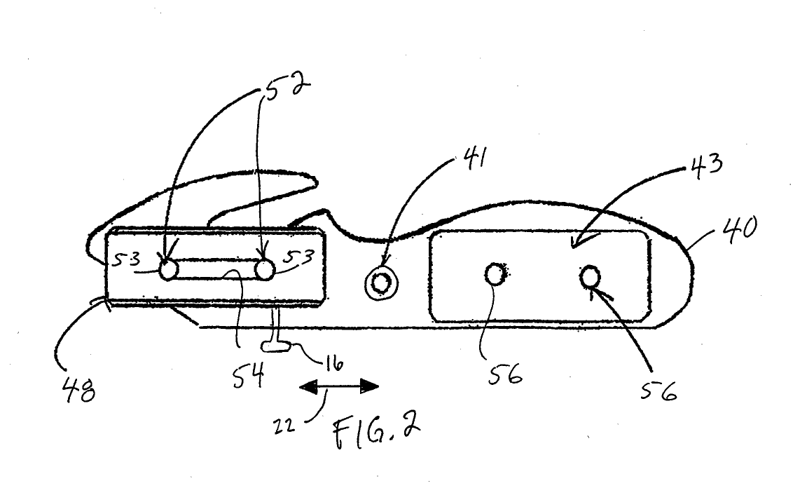

Turning first to FIG. 1, reference numeral 10 generally designates a casing for a utility knife, and reference numeral 11 identifies a double-sided utility blade. The casing 10 is formed of two sides, the left side being designated 12 (FIG. 1) and the right side designated 13, (FIG. 2), formed in generally mirror image to one another, and the two sides are held together by a conventional set screw 14 which threads into an internally threaded boss formed on the inside of the right side 13 which is shown in FIG. 2.

Turning to FIG. 1, the outline of the casing includes an inclined surface 18 extends which beyond the front edge of the blade 11, where it is curved as at 22 and extends in a broader curve, forming edge 24 to form the outer surface of a lift finger generally designated 26. Thereafter the contour of the casing 10 extends forwardly in a generally straight line as at 28 and then curves around toward the right side of the knife, forming curved surface 30. Thereafter the shape of the casing 10 forms another straight edge 32, and then the shape of the casing includes a broadly curved surface 34 for forming a grip, whether the knife is used for conventional cutting, as seen in the position of FIG. 1, or it is turned over to use the opposing edge 36 of the blade 11 which is exposed in the innermost portion of an opening or slot 31 formed by the edge 28, curved edge 30 and straight edge 32.

When used as a cutting device for furniture wrapping or other film or sheet material, the knife is turned over in the hand of a user from the position shown in FIG. 1, and a tip 37 of the finger 26 acts as a piercing member for forming an opening in the wrap or other sheet material intended to be cut. As the inverted knife is then moved rearwardly (to the right in FIG. 1) in the horizontal direction (so that the point 37 faces downwardly and to the right), once the wrap is pierced, the knife may be pulled to the right in FIG. so that the sheet material enters the slot 31 and is guided by the edge 37 into contact with the forwardmost portion of the blade edge 36, which is used for cutting the wrap or other sheet material.

Turning now to FIG. 2, there is seen the inside of the opposing or mating side or half generally designated 40, which, as can be seen, conforms to and matches the silhouette or outline of the first casing half 12. In addition, however, there is shown an internally threaded boss 41 for receiving the lock screw 14 of FIG. 1 to secure the two halves 12, 40 together. Further, there is formed in the enlarged handle portion of the casing 40, a recess 43 for storing double-edged utility blades, such as the ones shown at 48 in FIG. 2.

A pair of retaining or lock members, in the form of cylindrical bosses sized to fit into a center opening of the blade 48, designated 54 in FIG. 2. The elongated central opening 54 of the blade has opposing curved edges 53, 53 spaced and sized to engage the bosses 52, 52 to secure the blade 48 in the cutting position (for use in both of the two cutting actions described above).

Also, as can be seen in FIG. 2, a second pair of retainer bosses designated 56, 56 are formed also in the storage recess 43 of the knife. Retainers 56 are spaced laterally for fitting into the center opening 54 of the blade 48 to retain it in the blade storage recess 43.

A thumb slide 16 extends through a slot in the casing and is coupled to the double-edged cutting blade 48. Thumb slide 16 is adapted for manual engagement by a user of the utility knife for movement in the directions of arrow 22 for moving the double-edged cutting blade 48 between an extended, use position as shown in FIG. 2 and a retracted, stored position wherein the entire blade is disposed within the casing.

Having thus disclosed in detail an embodiment of the invention, persons skilled in the art will be able to modify the structure illustrated and substitute equivalent elements for those disclosed; and it is, therefore, intended that all such substitutions and equivalents be covered as they are embraced within the scope of the appended claims.

I claim:

1. A utility knife comprising:
a casing containing a generally rectangle, double-edged cutting blade;
a first end portion of said casing defining a first opening exposing a first edge of the cutting blade for cutting an object;
a second end portion of said casing extending from said first portion and forming a handle for grasping by a user of the knife; and
a finger extending from said first portion of said casing and forming an elongated slot with said first portion, wherein said slot includes a second opening exposing a second opposed edge of the cutting blade, and wherein said slot is adapted to receive and direct a sheet-like material into engagement with the second edge of the cutting blade for cutting the sheet-like material.

2. The utility knife of claim 1, wherein the first portion of said casing defining said first opening includes a generally flat edge containing said first opening.

3. The utility knife of claim 2, wherein said first opening is generally linear in shape.

4. The utility knife of claim 1, wherein said finger has a wide base extending from the first portion of said casing and narrows to a generally sharp tip on its distal end, and wherein said sharp tip is adapted for piercing the sheet-like material.

5. The utility knife of claim 4, wherein said elongated slot is formed by curvilinear facing sections of said finger and the first portion of said casing.

6. The utility knife of claim 5, wherein the facing sections of said finger and the first portion of said casing are disposed in spaced relation from one another and are aligned with one another.

7. The utility knife of claim 6, wherein the second cutting edge of the cutting blade is linear and spans the distance between adjacent inner curvilinear portions of said finger and the first portion of the casing.

8. The utility knife of claim 1, wherein first cutting edge forms a portion of a corner of said cutting blade.

9. The utility knife of claim 1, wherein said casing includes first and second halves adapted for mutual engagement for forming a generally closed structure.

10. The utility knife of claim 9 further comprising a coupler for connecting said first and second casing halves together.

11. The utility knife of claim 10, wherein said coupler is a threaded connector coupling said first and second casing halves together.

12. The utility knife of claim 1, wherein the second end portion of said casing includes an internal recessed portion adapted to receive and provide storage for a spare double-edged cutting blade.

13. The utility knife of claim 12 further comprising plural spaced bosses disposed in the internal recessed portion of the second end portion of said casing for insertion into an elongated slot or spaced apertures disposed in a spare double-edged cutting blade for securely maintaining said spare double-edged cutting blade in fixed position.

14. The utility knife of claim 1, wherein the first end portion of said casing includes an internal recessed portion containing plural spaced bosses, wherein said internal recessed portion is adapted to receive said rectangular, double-edged cutting blade and said spaced bosses are adapted for insertion into an elongated slot or spaced apertures in said double-edged cutting blade for securely maintaining said cutting blade in fixed position.

15. The utility knife of claim 1 further comprising a movable, manually engageable member coupled to the cutting blade for moving the cutting blade between a first position, wherein said cutting blade is retracted in said casing, and a second position, wherein said cutting blade extends through the first opening exposing the first edge of the cutting blade.

16. A utility knife having a double-edged blade, said utility knife comprising:
first and second half casing portions adapted for mutual engagement to form a generally closed casing;
a coupler engaging and securely connecting said first and second half casing portions together;
a first end portion of said closed casing forming a handle adapted for manual grasping by a user;
a second opposed end portion of said closed casing formed integrally with and extending from said first end portion of said casing, said second opposed end portion including a first opening through which a first corner edge of the double edged blade extends for cutting a first material; and
an elongated finger extending from and forming an extended narrow slot with the second end portion of said housing wherein said slot is adapted for receiving a second sheet-like material, said slot including a second opening through which a second opposed, elongated edge of the double-edged blade extends for cutting said second sheet-like material, and wherein said finger includes a generally sharp tip adapted for piercing the sheet-like material.
